(19) United States
(12) Patent Application Publication
(10) Pub. No.: US 2025/0110801 A1
(43) Pub. Date: Apr. 3, 2025

(54) SYSTEMS AND METHODS FOR RESOURCE SHARING

(71) Applicant: The Surpluss LLC, Ajman (AE)

(72) Inventor: Rana Hajirasouli, Ajman (AE)

(21) Appl. No.: 18/792,296

(22) Filed: Aug. 1, 2024

Related U.S. Application Data
(60) Provisional application No. 63/530,651, filed on Aug. 3, 2023.

(51) Int. Cl. G06F 9/50

(52) U.S. Cl. CPC G06F 9/5077

(57) ABSTRACT

Disclosed are example embodiments of systems and methods for facilitating resource sharing among entities. An example digital platform for facilitating resource sharing among entities, includes a user interface accessible by entities via electronic devices. The example digital platform for facilitating resource sharing among entities, also includes a database for storing information related to underutilized resources of the entities. Additionally, the example digital platform for facilitating resource sharing among entities, includes a search engine configured to facilitate discovery of underutilized resources based on specified criteria, and a collaboration module enabling entities to establish resource sharing agreements and engage in collaborative projects pertaining to at least one of knowledge, byproducts, waste, and surplus.

### CROSS-REFERENCE TO RELATED APPLICATION

This present application claims priority to U.S. Provisional Patent Application No. 63/530,651, filed on Aug. 3, 2023, entitled “SYSTEMS AND METHODS FOR RESOURCE SHARING”, which is reference herein in its entirety.

### TECHNICAL FIELD

The disclosure relates generally to the field of a digital platform that facilitates resource sharing among individuals, groups, businesses, or other entities to do one or more of enhance sustainability, foster innovation, or improve competitiveness and specifically and not by way of limitation, the systems and methods described herein provides an ecosystem wherein the individuals, groups, businesses, or other entities can efficiently share their underutilized resources.

### BACKGROUND

In today's rapidly changing business landscape, organizations face increasing pressure to optimize resource utilization, reduce waste, and embrace sustainable practices. Simultaneously, innovation and competitiveness have become crucial factors for business success and growth.

While there have been efforts to promote resource sharing and sustainability, the existing methods and platforms face significant limitations. Traditional approaches to resource sharing often involve complex negotiations, limited networks, and fragmented processes, making it challenging for businesses to find suitable partners and maximize the utilization of underutilized resources.

Furthermore, the need for businesses to stay competitive and drive innovation often necessitates access to diverse resources and expertise that may not be readily available within their own organization. Collaboration across industries and sectors may be needed for unlocking new opportunities, sharing knowledge, and driving collective growth.

Therefore, there is a need for a comprehensive digital platform that offers an ecosystem where businesses can efficiently share their underutilized resources, enhance sustainability, foster innovation, and/or gain a competitive edge.

### SUMMARY

In one example implementation, an embodiment includes one or more of systems and methods for facilitating resource sharing among entities.

An example digital platform for facilitating resource sharing among entities, includes a user interface accessible by entities via electronic devices. The example digital platform for facilitating resource sharing among entities, also includes a database for storing information related to underutilized resources of the entities. Additionally, the example digital platform for facilitating resource sharing among entities, includes a search engine configured to facilitate discovery of underutilized resources based on specified criteria, and a collaboration module enabling entities to establish resource sharing agreements and engage in collaborative projects pertaining to at least one of knowledge, byproducts, waste, and surplus.

An example method for facilitating resource sharing among entities to enhance sustainability and innovation, includes the step of providing a digital platform accessible by entities via electronic devices. The method also includes the step of storing information related to underutilized resources of said entities in a database. Additionally, the method includes enabling entities to search for underutilized resources based on specified criteria using a search engine, and facilitating establishment of resource sharing agreements and collaborative projects among entities using a collaboration module pertaining to at least one of knowledge, byproducts, waste, and surplus.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram that illustrates an example system architecture of a platform in accordance with the systems and methods described herein.

FIG. 2 is a diagram illustrating the system architecture of the digital platform for facilitating resource sharing among organizations in accordance with the systems and methods described herein.

FIG. 3 is a flow diagram illustrating the operational flow of an example embodiment of an example platform according to the systems and methods described herein.

FIG. 4 is a flow diagram illustrating a method for facilitating resource sharing among entities to enhance sustainability and innovation in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present invention addresses the aforementioned challenges by providing a digital platform that enables businesses (or other entities) to share underutilized resources and leverage collaborative opportunities. By utilizing this platform, businesses (or other entities) can enhance sustainability practices, foster innovation through cross-industry collaboration, and improve their competitive position in the market.

The platform establishes a digital ecosystem where businesses (or other entities) from various sectors can connect, discover underutilized resources, initiate resource sharing agreements, and collaborate on projects. It offers a user-friendly interface, advanced search capabilities, and efficient communication tools to streamline the resource sharing process and facilitate effective collaboration.

In addition to enabling businesses (or other entities) to share underutilized resources, the platform incorporates features that promote sustainability and innovation. It provides tools for tracking and analyzing environmental performance, generating reports on resource utilization, and offering insights to drive sustainable decision-making. The platform also fosters a community of like-minded businesses (or other entities), encouraging knowledge exchange, networking, and continuous learning.

Through the utilization of this platform, businesses (or other entities) can unlock the full potential of their underutilized resources, reduce waste, minimize environmental impact, drive innovation through cross-collaboration, and gain a competitive advantage in their respective industries.

As used herein, entities may include individuals, businesses, nonprofit organizations, government agencies, educational institutions, religious institutions, clubs or associations, research institutes or laboratories, community organizations, professional associations, financial institutions, healthcare organizations, cultural or arts organizations, environmental organizations, or any other organizations, or entities.

Some embodiments of the systems and methods described herein may provide a digital platform that may facilitate resource sharing among organizations such as individuals, businesses, government agencies, or any other organizations, or any other entities to enhance sustainability, foster innovation, improve competitiveness, or any combination of enhance sustainability, foster innovation, and improve competitiveness. In some example embodiments, the platform may provide a digital ecosystem where organizations may share their underutilized resources, such as Knowledge, Byproduct, Waste, Surplus, in an efficient and collaborative manner. Some example platforms may provide a digital ecosystem where organizations may share their underutilized resources, such as raw materials, equipment, facilities, expertise, and capacity.

In some embodiments, the platform addresses the real problem of a lack of cross-industrial engagement to contribute towards industry-level coordination of climate change. This includes exchanging byproducts, waste, knowledge and surplus assets, surplus space, surplus logistics, or other surplus. Companies can reduce their greenhouse gas emissions by way of entering into “synergies” that are in correspondence with the UN Sustainable Development Goals, deepening their engagement, building capacity and trust across industries. Fundamentally, the systems and method described herein may digitize a process that may be referred to as “industrial symbiosis.” These exchanges aim to reduce resource inefficiencies, waste, and air pollution amongst companies (or other entities). However, until today, a successful digital model of this physical process has yet to be implemented successfully.

Historically, industrial symbiosis platforms have existed in the past but have failed to launch as many use-recommender systems which do not work for complex exchanges.

Fundamentally, even two very similar companies operating within the same geographic region could in theory have two similar outputs, but input-output matching has never worked as it is a linear process that relies too heavily on the data quality being the same.

Similarly, these types of platforms exist but have replaced the recommender system with physical facilitation (e.g., a person matching two companies together). Circular marketplace exchanges also exist but operate more towards being a scrap market rather than a platform for climate action. Our methodology enables a database for companies to strengthen engagement, rather than focus on the quality of output materials in a robust way.

An example embodiment of the systems and methods described herein may aim to make the platform open access at some point, where data may provide intelligent insights for companies to be able to respond to climate change. The systems and methods described herein may use four categories (where many of the previous platforms which have failed to secure critical mass require a high level of technical knowledge and are mostly designed for engineers to use). These four categories aim to sum up, in simple terms, every “excess resource” a company (or other entity) has within the company's carrying capacity.

The four categories may include:

Knowledge: to qualify for this, companies can post up excess knowledge hours any of their employees have to drive sustainability capacity and can offer other industrial actors assistance to become more sustainable. An example of this is your firm has two junior lawyers who can provide four hours of discounted workshops for small to medium enterprises (SMEs), e.g., in some examples, enterprises with less than 500 employees, in other examples, enterprises with less than 250 employees, to understand local environmental regulations. This can also be a source of new revenue for your company.

Byproduct: companies can better understand their operations by quantifying how much byproducts they use. These are production materials that are created as an unusable excess as a part of a production process and may be sent to a landfill. Examples of this are salt from a desalination plant, or sawdust at a sawmill that can be sold onto another industry to replace virgin materials.

Waste: any recyclable waste (non-hazardous or toxic) that can be reused by other companies who have a requirement for it. Examples are pallet wood from shipping containers that can be used to replace conventional wood for more circular furniture design.

Surplus: a category designed to address the needs of any non-production related excess resources. They can be summed up into assets and physical space. Examples may include but are not limited to excess warehouse space which can be rented out, leasing out manufacturing equipment such as idle machinery (e.g., a forklift), and co-sharing logistics where there is extra space, to reduce costs.

Some embodiments of the systems and methods described herein may solve one or more of the problems described herein by simplifying the language and technical understanding needed to contribute and part-take in sustainable business models. The systems and methods described herein may also simplify the exchange process by providing a platform which may be easy to navigate and use, requiring only minimal training to use, e.g., 15 minutes of training.

It is worth noting that, aside from “waste” and “byproducts” no other platform has currently used this framework and categories in combination. The concept of “surplus” and “knowledge” may be used to build on the idea of symbiotic partnerships and not neglect the importance of knowledge sharing and excess in forms of physical assets.

Current software and industrial symbiosis platforms do not solve the problem as they are linear, and lack the critical mass for widespread adoption, and the input/outputs do not match. There is no simplified web-application that currently maps the way the systems and methods described herein map, e.g., using the categories described herein.

Physical facilitators can identify potential for synergies to reduce landfill waste, governments can also legislate to encourage industrial symbiosis adoption. Additionally, other alternatives may require human expertise, capital allocation, travel, etc., as an alternative to a digital platform.

In some examples, companies can hire onboard a specialist in-house sustainability department, or external agency, but there is currently no simple, cheap, and fast way to accomplish the above. Currently, it is applied in a business-to-business (B2B) context. This is between industrial actors which can benefit most if they do currently have underutilized resources to share, exchange, sell, etc. However, service-driven industries (such as advertising, marketing, health-tech, or other service-driven industries) can also apply this to the digital space (such as exchanging knowledge) to overcome barriers to sustainability. The platform is sector agnostic.

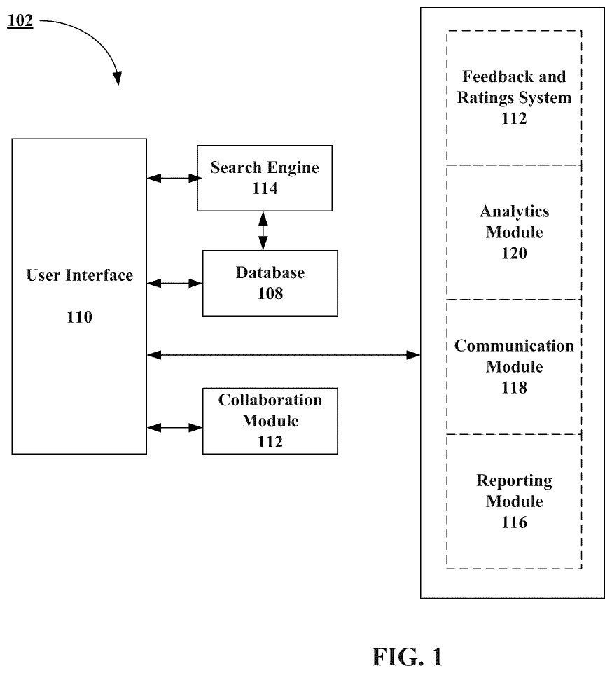

FIG. 1 is a diagram that illustrates an example system architecture of platform 102 in accordance with the systems and methods described herein. Platform 102 may include multiple components that may be interconnected. These components may enable resource sharing, collaboration, sustainability enhancement, or some combination of these among entities. For example, the systems and methods described herein may include one or more of a user interface 110, a database 108, a search engine 114, a collaboration module 112, and may include an analytics module 120.

Some example embodiments may include a user interface (UI) 110. For example, platform 102 may provide a user interface 110 accessible by entities via electronic devices. Electronic devices may include, but are not limited to computers, smartphones, tablets, or other electronic devices. User interface 110 may enable entities to interact with platform 102, search for underutilized resources, initiate resource sharing agreements, and collaborate on projects. The user interface 110 may offer intuitive and user-friendly features to facilitate seamless navigation and efficient utilization of the platform's functionalities.

In some example embodiments, the platform may include a comprehensive onboarding process where entities are guided through creating their profiles. During this process, entities may customize their profiles by specifying their industry, operational focus, and the types of resources they have available for sharing. The customization options may allow entities to highlight their unique capabilities, such as specialized equipment or rare expertise, making it easier for others to identify potential synergies. The onboarding process may also include a tutorial on navigating the platform, ensuring that all users can efficiently utilize the platform's features from the outset.

Some example embodiments may include database 108. For example, platform 102 may incorporate database 108 that stores information related to underutilized resources offered by participating entities. Database 108 may include comprehensive profiles of entities, including details of the entities underutilized resources, availability, specifications, and any relevant restrictions or conditions for sharing. Database 108 may be designed to facilitate efficient searching and matching of underutilized resources based on specified criteria.

In some embodiments, the platform may integrate with external databases and data sources, allowing entities to import and synchronize their existing data with the platform's database. This integration may help ensure that all relevant resource information is up-to-date and accurate, facilitating more effective resource sharing and collaboration. Entities may leverage this feature to streamline data management processes, reduce duplication of effort, and maintain consistency across different systems.

In some embodiments, the platform provides customizable user permissions and role-based access control, ensuring that only authorized personnel can access specific functionalities and sensitive information. Administrators can assign roles such as viewer, contributor, or manager, each with different levels of access and capabilities. This feature enhances security and allows entities to manage their internal teams effectively, ensuring that the right individuals have the appropriate level of access to the platform's resources and tools.

Some example embodiments may include a search engine 114. For example, the platform may integrate a search engine 114 that allows entities to discover and identify underutilized resources based on the entity's specific requirements. The search engine 114 may utilize advanced algorithms to analyze the database and provide accurate and relevant search results. Entities may define search criteria such as resource type, quantity, location, and other customizable parameters to find suitable resource sharing opportunities.

In some example embodiments, the search engine may be integrated into the platform offers advanced filtering mechanisms, enabling entities to refine their search results based on a variety of criteria. Users may filter resources by availability dates, geographic proximity, resource specifications, and compliance with specific industry standards. Additionally, the platform may support keyword searches and Boolean operators, allowing users to combine multiple search criteria to find the most relevant resources. The platform's search engine may leverage machine learning algorithms to improve search accuracy over time, by learning from user interactions and feedback

Some example embodiments may include a collaboration module 112. The collaboration module 112 may be a component of the platform, enabling entities to establish resource sharing agreements, engage in collaborative projects, or both. The collaboration module 112 may provide functionalities for entities to negotiate terms, define resource utilization timelines, allocate responsibilities, or some combination of negotiating terms, defining resource utilization timelines, and allocating responsibilities. The collaboration module 112 may support seamless communication and coordination between entities, facilitating efficient collaboration and effective utilization of shared resources.

In some example embodiments, security and data privacy may be dealt with within the platform. For example, the communication module may ensure secure exchanges between entities through end-to-end encryption. Users may communicate via secure messaging, video calls, or secure document sharing, all facilitated within the platform. The platform may comply with international data protection regulations, ensuring that all personal and business data are stored securely. Users may also set privacy preferences, controlling who can view their resources and contact them. The platform's security infrastructure may include regular audits and updates to protect against unauthorized access and data breaches

Some example embodiments may include an analytics module 120. For example, to enhance sustainability practices, the platform may include an analytics module 120 that may track and analyze the environmental performance of entities participating in resource sharing. The analytics module may collect data on resource utilization, waste reduction, energy consumption, and other relevant metrics. The analytics module 120 may generate comprehensive reports and provides actionable insights to entities, allowing them to monitor and optimize the entity's sustainability efforts.

The analytics module 120 may leverage advanced analytics and machine learning algorithms to provide predictive insights and trend analysis. By analyzing historical data and user interactions, the platform may forecast future resource availability, identify potential collaboration opportunities, and suggest optimal resource utilization strategies. These capabilities may enable entities to make data-driven decisions, enhance operational efficiency, and proactively address sustainability challenges.

Some example embodiments may include a reporting module 116. The reporting module 116 may generate reports that provide detailed information on resource utilization, sustainability metrics, and collaboration outcomes. These reports may help entities evaluate the impact of resource sharing, identify areas for improvement, and make data-driven decisions. The reporting module may support customizable report generation, allowing entities to focus on key performance indicators aligned with the entity's sustainability goals.

In some example embodiments, the platform supports tracking and reporting on sustainability metrics, such as carbon footprint, energy consumption, and waste reduction. The platform may also integrate with third-party sustainability certification programs, helping entities achieve recognized standards and certifications. By providing detailed metrics and certification support, the platform assists entities in demonstrating their commitment to sustainability and enhancing their reputation in the market.

In some example embodiments, the analytics module may provide a user-friendly interface where entities can access a dashboard of metrics and analytics related to their resource sharing activities. Users may customize the dashboard to display specific metrics relevant to their sustainability and operational goals. The module may track metrics such as carbon footprint reduction, cost savings from shared resources, and the number of successful collaborations. Users may generate reports in various formats, including PDFs and spreadsheets, and can schedule regular report generation and distribution. The module may also offer predictive analytics, providing insights into future resource needs and potential collaboration opportunities.

In some example embodiments, the platform supports integration with external systems and APIs, enabling entities to synchronize their existing enterprise resource planning (ERP) systems with the platform. This integration may facilitate seamless data flow between the platform and entities' internal systems, ensuring that resource availability and usage data are always up-to-date. The platform may also integrate with external sustainability tracking tools, allowing entities to consolidate their sustainability metrics in one place. APIs may be available for developers to build custom applications or tools that extend the platform's functionalities, such as mobile apps for on-the-go access

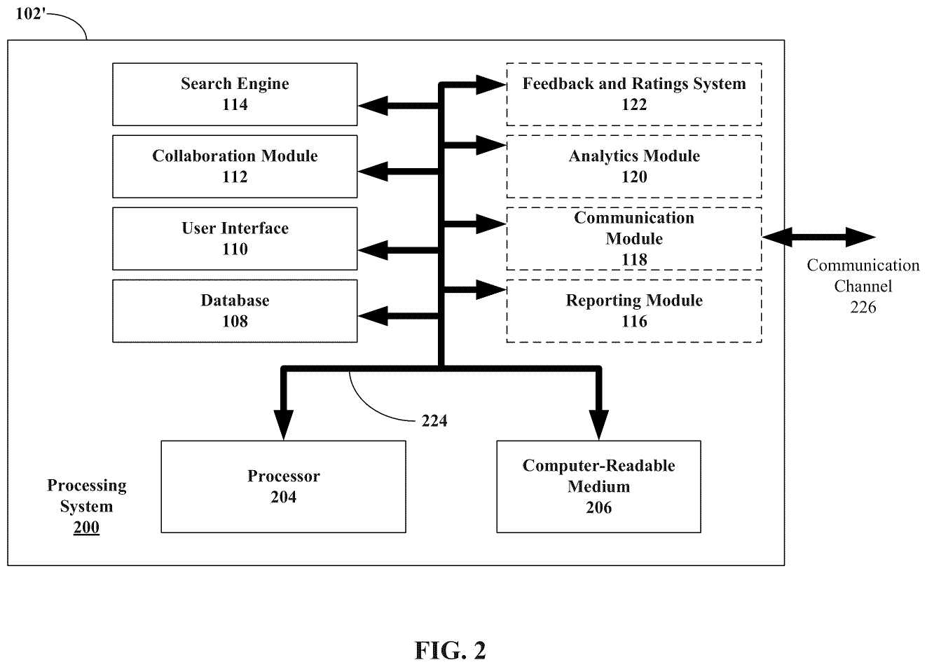

FIG. 2 provides an example of a hardware implementation for an apparatus 102′ employing a processing system 200. The processing system 200 may be implemented with a bus architecture, represented generally by the bus 224. The bus 224 may include any number of interconnecting buses and bridges depending on the specific application of the processing system 200 and the overall design constraints. Bus 224 links together various circuits including one or more processors and/or hardware modules, represented by the processor 204, the modules 208, 110, 112, 114, 116, 118, 120, 122, and the computer-readable medium 106. The bus 224 may also link various other circuits such as timing sources, peripherals, voltage regulators, and power management circuits, which are well known in the art, and therefore, will not be described any further.

The processing system 200 includes a processor 204 coupled to a computer-readable medium 106. Processor 204 is responsible for general processing, including the execution of software stored on computer-readable medium 106. The software, when executed by processor 204, causes the processing system 200 to perform the various functions described supra for any particular apparatus. The computer-readable medium 106 may also be used for storing data that is manipulated by processor 204 when executing software. The processing system further includes at least one of the modules 208, 110, 112, 114, 116, 118, 120, 122. The modules may be software modules running in processor 204, resident/stored in the computer readable medium 106, one or more hardware modules coupled to the processor 204, or some combination thereof.

The apparatus 200/102′ may provide a digital platform accessible by entities via electronic devices. In one example configuration, the apparatus 200/202′ for facilitating resource sharing among entities includes means for storing information related to underutilized resources of said entities in a database (e.g., computer-readable medium 106). The apparatus 200/202′ for facilitating resource sharing among entities includes means for enabling entities to search for underutilized resources based on specified criteria using a search engine (e.g., search engine 114 0may be configured to search database 208). The apparatus 200/202′ for facilitating resource sharing among entities includes means for facilitating establishment of resource sharing agreements and collaborative projects among entities using a collaboration module 112 pertaining to at least one of knowledge, byproducts, waste, and surplus (e.g., collaboration module 112). In an example embodiment, the underutilized resources may be raw materials, equipment, facilities, expertise, or capacity.

In an example embodiment, the apparatus 200/202′ for facilitating resource sharing among entities includes means for tracking and analyzing environmental performance of entities participating in resource sharing, e.g., using an analytics module 120.

The apparatus 200/202′ for facilitating resource sharing among entities includes means for generating reports and providing insights on resource utilization and sustainability metrics, e.g., using a reporting module 116.

The apparatus 200/202′ for facilitating resource sharing among entities includes means for enabling communication, negotiation, and coordination of resource sharing activities among entities using a communication module.

The apparatus 200/202′ for facilitating resource sharing among entities includes means for providing a feedback and rating system allowing entities to provide feedback and rate the quality of shared resources and collaboration experiences, e.g., feedback and ratings module 122.

The apparatus 200/202′ for facilitating resource sharing among entities includes means for the feedback and rating system to allow entities to rate the reliability, responsiveness, and overall satisfaction with shared resources and collaboration experiences (e.g., feedback and rating system 122 possibly in conjunction with the user interface 110).

The apparatus 200/202′ for facilitating resource sharing among entities includes means for validating the availability and suitability of underutilized resources before establishing resource sharing agreements.

The apparatus 200/202′ for facilitating resource sharing among entities includes means for monitoring resource utilization and waste reduction metrics to measure the environmental impact of resource sharing activities.

The apparatus 200/202′ for facilitating resource sharing among entities includes means for analyzing collaboration patterns and outcomes to identify opportunities for innovation and process improvement.

The apparatus 200/202′ for facilitating resource sharing among entities includes means for sending notifications and alerts to entities regarding new underutilized resources, collaboration opportunities, and feedback received (e.g., communication module 118).

The aforementioned means may be one or more of the aforementioned modules of the apparatus 100 and/or the processing system 200 of the apparatus 102′ configured to perform the functions recited by the aforementioned means.

FIG. 2: System Architecture of the Digital Platform

FIG. 2 is a diagram illustrating the system architecture of the digital platform for facilitating resource sharing among organizations in accordance with the systems and methods described herein. The platform comprises multiple interconnected components that work together to enable efficient resource sharing and collaboration.

FIGS. 1 and 2 illustrate the following components. User Interface (UI) 110: The user interface 110 is accessible to entities via electronic devices such as computers, smartphones, or tablets. User interface 110 provides a graphical interface through which entities can interact with the digital platform. The UI 110 offers intuitive features and functionalities that allow entities to search for underutilized resources, initiate resource sharing agreements, and engage in collaborative projects.

The platform incorporates database 108 for storing information related to the underutilized resources of entities. Database 108 is designed to efficiently organize and manage the data, including details such as resource descriptions, availability, specifications, and any relevant terms or conditions associated with sharing. This centralized repository enables entities to easily access and share information about their underutilized resources.

The digital platform includes a search engine 114 that is configured to facilitate the discovery of underutilized resources based on specified criteria. Entities can input their resource requirements, such as type, quantity, location, or specific attributes, into the search engine. Search engine 114 employs advanced algorithms to analyze the information stored in the database and provide entities with relevant search results, thereby facilitating efficient resource discovery.

The collaboration module 112 may play a role in enabling entities to establish resource sharing agreements and engage in collaborative projects. This module provides functionalities that allow entities to negotiate terms, define resource utilization timelines, and allocate responsibilities. It facilitates seamless communication and coordination between entities, ensuring effective collaboration and utilization of shared resources.

The components depicted in FIG. 2 may work in tandem to create a digital ecosystem that enhances resource sharing among organizations. The user interface may serve as the primary interface for entities to interact with the platform, while the database stores and organizes information about underutilized resources. The search engine may enable entities to discover relevant resources based on their specified criteria, and the collaboration module facilitates the establishment of resource sharing agreements and collaborative projects.

Overall, FIG. 2 demonstrates the interconnectedness of these components in the digital platform, providing a visual representation of how they contribute to facilitating resource sharing among organizations. In some example embodiments, underutilized resources may include raw materials, equipment, facilities, expertise, or capacity. In some example embodiments, the digital platform may further include an analytics module for tracking and analyzing the environmental performance of entities participating in resource sharing and a reporting module for generating reports and providing insights on resource utilization and sustainability metrics. In some example embodiments, a communication module may enable entities to communicate, negotiate, and coordinate resource sharing activities. In some example embodiments, a feedback and rating system may allow entities to provide feedback and rate the quality of shared resources and collaboration experiences.

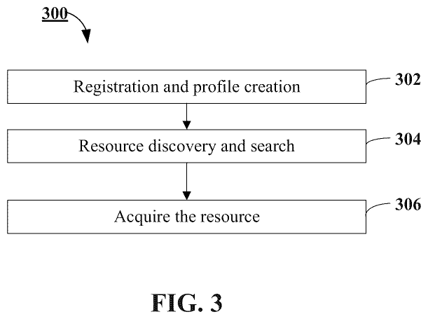

FIG. 3 is a flow diagram illustrating the operational flow 300 of an example embodiment of an example platform according to the systems and methods described herein. The example operational flow may illustrate example steps that may be used in resource sharing and collaboration.

Example steps may include registration and profile creation (302). Entities interested in participating in the resource sharing ecosystem register on the platform by providing relevant information about their organization, such as their industry, location, and underutilized resources. Upon registration, each business creates a profile within the platform, describing their underutilized resources, availability, and any specific terms or conditions associated with sharing.

Example steps may also include resource discovery and search (304). Once registered, entities can explore the platform's database and utilize the search engine to discover underutilized resources that match their requirements. The search engine provides advanced filtering options, allowing entities to narrow down their search based on resource type, location, and availability.

The entity may then acquire the resource (306) found in the search (or decide not to acquire the resource and potentially keep looking). For example, the entity may purchase the resource, may barter for the resource, may trade a resource they have for the resource they have found, or in some other way convince the owner of a resource to provide that resource to them.

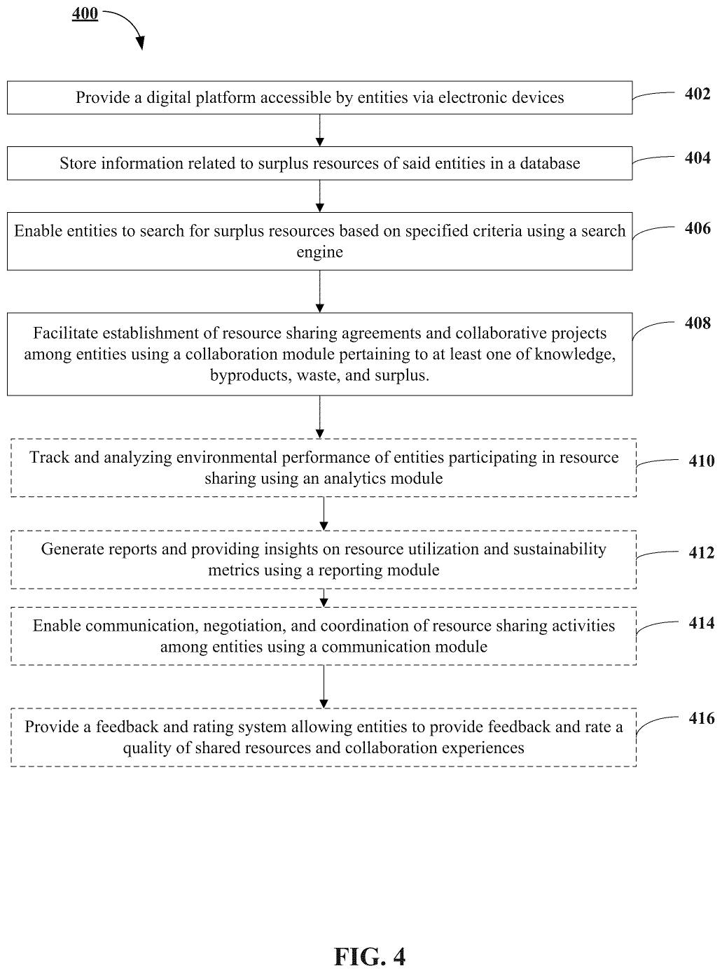

FIG. 4 is a flow diagram illustrating a method for facilitating resource sharing among entities to enhance sustainability and innovation in accordance with the systems and methods described herein. The method involves several steps that may be performed within a digital platform, as described in the following sections.

The method may begin by providing a digital platform (402) that may be accessible to entities via electronic devices such as computers, smartphones, or tablets. This platform serves as a central hub for entities to engage in resource sharing activities and collaborate with one another. Providing a digital platform (402) may include providing the hardware needed for the digital platform and programing the hardware to perform the steps necessary to perform the systems and methods described herein.

Information related to the underutilized resources of entities may be stored (404) in a database within the digital platform. The database may act as a repository for comprehensive profiles of entities, including details of their underutilized resources, availability, specifications, and any specific terms or conditions associated with sharing. Information related to the underutilized resources of entities may be stored (404) in a database within the digital platform may include providing storage for the database, e.g., using computer memory, disk drives, cloud storage, or any other appropriate computer storage. Determining data to be written into the database and writing the data into the database.

Entities may be enabled to search for underutilized resources based on specified criteria (406) using a search engine integrated within the digital platform. The search engine may utilize advanced algorithms to analyze the information stored in the database and provide entities with relevant search results. This may allow entities to discover underutilized resources that match the entity's specific requirements.

The method further includes facilitating the establishment of resource sharing agreements and collaborative projects among entities using a collaboration module within the digital platform (408). The collaboration module may provide functionalities that enable entities to negotiate terms, define resource utilization timelines, and allocate responsibilities. Some embodiments of the systems and methods described herein may ensure seamless communication and coordination between entities, fostering effective collaboration and utilization of shared resources. Facilitating the establishment of resource sharing agreements and collaborative projects among entities using a collaboration module within the digital platform (408) may include facilitating, e.g., enabling or supporting the process of establishing resource sharing agreements and collaborative projects among entities, establishment of resource sharing agreements, e.g., the action of creating agreements or arrangements for sharing resources among the entities involved. These agreements could involve sharing assets, services, personnel, or any other resources that are mutually beneficial, establishment of collaborative projects, e.g., initiating collaborative projects among the entities. These projects involve joint efforts, cooperation, and coordination to achieve common goals or objectives, and these may be among entities, e.g., resource sharing agreements and collaborative projects may be established between multiple entities. These entities can be individuals, organizations, businesses, or any other identifiable parties involved in the digital platform. Using a collaboration module may include utilizing a specific module or functionality within the digital platform to facilitate the establishment of resource sharing agreements and collaborative projects. The collaboration module could be a dedicated feature, tool, or interface within the platform that enables communication, coordination, and management of these agreements and projects.

In addition to the steps outlined above, the method may include one or more of the following additional steps.

The method may involve tracking and analyzing the environmental performance of entities participating in resource sharing using an analytics module within the digital platform (410). This module may collect data on resource utilization, waste reduction, energy consumption, and other relevant metrics. The module may generate comprehensive reports and provides actionable insights to entities, allowing them to monitor and optimize their sustainability efforts. Tracking and analyzing the environmental performance of entities participating in resource sharing using an analytics module within the digital platform (410) may include tracking the environmental performance of entities participating in resource sharing using an analytics module within the digital platform and analyzing the environmental performance of entities participating in resource sharing using an analytics module within the digital platform.

The method may also include generating reports and providing insights on resource utilization and sustainability metrics using a reporting module within the digital platform (412). These reports may provide detailed information on resource utilization, sustainability metrics, and collaboration outcomes. The reports may help entities evaluate the impact of resource sharing, identify areas for improvement, and make data-driven decisions. Generating reports and providing insights on resource utilization and sustainability metrics using a reporting module within the digital platform (412) may include gathering data, generating a report based on the data gathered, analyzing the data to develop insights, and transmitting those insights to a user.

The method may further involve enabling communication, negotiation, and coordination of resource sharing activities among entities using a communication module within the digital platform (414). This module facilitates seamless communication channels and collaboration tools that allow entities to effectively engage in discussions, negotiate terms, and coordinate resource sharing activities. Enabling communication, negotiation, and coordination of resource sharing activities among entities using a communication module within the digital platform (414) may include developing a message regarding resource sharing activities among entities and transmitting that message, e.g., to a device and/or a user using such a device. The communication may be bi-directional, which may allow for negotiation and coordination.

The method may also include providing a feedback and rating system within the digital platform, allowing entities to provide feedback and rate the quality of shared resources and collaboration experiences (416). This system may enable entities to share their experiences, provide valuable feedback, and rate the effectiveness and reliability of the shared resources and collaborative projects. Providing a feedback and rating system within the digital platform, allowing entities to provide feedback and rate the quality of shared resources and collaboration experiences (416) may include collecting feedback from, e.g., users and storing data from the feedback, e.g., in a database, and/or collecting rating information from, e.g., users and storing data from the rating information, e.g., in a database.

For example, a platform incorporating the method may include mechanisms for collecting and analyzing user feedback, which is crucial for continuous improvement. Entities may provide feedback on their experiences with resource sharing, the quality of resources received, and the overall user experience. This feedback may be analyzed to identify areas for enhancement and to develop new features that better meet user needs. The platform may continuously evolve based on user input, ensuring that it remains responsive to the dynamic requirements of its users.

Overall, FIG. 4 presents a flowchart that demonstrates the sequential steps involved in the method for facilitating resource sharing among entities. It showcases the core steps of providing a digital platform, storing information, enabling search, and facilitating resource sharing, along with additional steps related to tracking environmental performance, generating reports, enabling communication, and providing a feedback and rating system.

The systems and methods described herein are described with respect to various companies, businesses, or other entities. It will be understood that the systems and methods described herein may be used by almost any entity or person, e.g., through the actions of employees in the case of businesses or companies, and/or by individuals or groups of people for various other entities.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A digital platform for facilitating resource sharing among entities, comprising:
a user interface accessible by entities via electronic devices;
a database for storing information related to underutilized resources of the entities;
a search engine configured to facilitate discovery of underutilized resources based on specified criteria; and
a collaboration module enabling entities to establish resource sharing agreements and engage in collaborative projects pertaining to at least one of knowledge, byproducts, waste, and surplus.

2. The digital platform of claim 1, wherein the underutilized resources comprise raw materials, equipment, facilities, expertise, or capacity.

3. The digital platform of claim 1, further comprising:
an analytics module for tracking and analyzing environmental performance of entities participating in resource sharing; and
a reporting module for generating reports and providing insights on resource utilization and sustainability metrics.

4. The digital platform of claim 3, wherein the analytics module tracks and analyzes metrics related to waste reduction, energy consumption, carbon footprint, or environmental impact.

5. The digital platform of claim 3, wherein the reporting module generates reports on resource utilization efficiency, sustainability performance, environmental benchmarks, or recommendations for improvement.

6. The digital platform of claim 1, further comprising a communication module enabling entities to communicate, negotiate, and coordinate resource sharing activities.

7. The digital platform of claim 6, wherein the communication module facilitates real-time messaging, negotiation, and coordination of resource sharing activities among entities.

8. The digital platform of claim 6, wherein the communication module supports file sharing, document collaboration, and scheduling of resource sharing activities among entities.

9. The digital platform of claim 1, further comprising a feedback and rating system allowing entities to provide feedback and rate a quality of shared resources and collaboration experiences.

10. A method for facilitating resource sharing among entities, comprising the steps of:
providing a digital platform accessible by entities via electronic devices;
storing information related to underutilized resources of said entities in a database;
enabling entities to search for underutilized resources based on specified criteria using a search engine; and
facilitating establishment of resource sharing agreements and collaborative projects among entities using a collaboration module pertaining to at least one of knowledge, byproducts, waste, and surplus.

13. The method of claim 12, wherein the underutilized resources comprise raw materials, equipment, facilities, expertise, or capacity.

12. The method of claim 10, further comprising the step of tracking and analyzing environmental performance of entities participating in resource sharing using an analytics module.

13. The method of claim 10, further comprising the step of generating reports and providing insights on resource utilization and sustainability metrics using a reporting module.

14. The method of claim 10, further comprising the step of enabling communication, negotiation, and coordination of resource sharing activities among entities using a communication module.

15. The method of claim 10, further comprising the step of providing a feedback and rating system allowing entities to provide feedback and rate a quality of shared resources and collaboration experiences.

16. The method of claim 15, wherein the feedback and rating system allows entities to rate the reliability, responsiveness, and overall satisfaction with shared resources and collaboration experiences.

17. The method of claim 10, further comprising the step of validating the availability and suitability of underutilized resources before establishing resource sharing agreements.

18. The method of claim 10, further comprising the step of monitoring resource utilization and waste reduction metrics to measure the environmental impact of resource sharing activities.

19. The method of claim 10, further comprising the step of analyzing collaboration patterns and outcomes to identify opportunities for innovation and process improvement.

20. The method of claim 10, further comprising the step of sending notifications and alerts to entities regarding new underutilized resources, collaboration opportunities, and feedback received.
